(19) United States
(12) Patent Application Publication
(10) Pub. No.: US 2009/0308958 A1
(43) Pub. Date: Dec. 17, 2009

(54) Method of Breaking Off Casting

(76) Inventor: Yasuaki Okuya, Nishio-shi (JP)

Correspondence Address: EDWARDS ANGELL PALMER & DODGE LLP, P.O. BOX 55874, BOSTON, MA, 02205, US

(21) Appl. No.: 12/223,325

(22) PCT Filed: Jan. 30, 2006
(86) PCT No.: PCT/JP2006/301918

§ 371 Date: Oct. 15, 2008

(51) Int. Cl. B02C 1/00

(52) U.S. Cl. 241/30

(57) ABSTRACT

A breaking method in the related art includes first and second cutter devices each opening in the top and bottom faces, a number of projection-shaped first cutters provided to the first cutter device so as to protrude in a staggered fashion, the second cutter device and a number of projection-shaped second cutters provided to the second cutter device so as to protrude in a staggered fashion having a fact-to-face relation with the first cutter device and the first cutters, respectively, and mobile means that allows the second cutter device to move. Weirs and runners that are now useless and useless cast raw materials (referred to as useless cast raw materials), etc. are placed inside from a placement opening defined between the first cutter device and the second cutter device when the second cutter device is retracted. The useless cast raw materials are then crushed and broken using a fitting relation between the second cutters of the second cutter device that is moved forward by the cylinder and the first cutters of the first cutter device. In a case where an abnormal load is applied to the second cutters (second cutter device) in motion, the second cutters are retracted or stopped by the action of the safety mechanism. Broken recycled cast products (recycled cast) are discharged by natural fall from a discharge port (outlet) defined between the first cutter device and the second cutter device when the second cutter device is retracted.

The invention is a cast breaking method for crushing and breaking a useless cast raw material by placing the useless cast raw material inside from a placement opening formed above by a first cutter device provided with a first cutter that converges toward a tip end and a second cutter device facing the first cutter device and provided with a second cutter that faces the first cutter and converges toward a tip end as well as having a fulcrum shaft on a lower side by means of a pressing action to press the placed useless cast raw material through a movement of the second cutter device along a circular trajectory using mobile means having a fulcrum shaft on an upper side of the second cutter device and a breaking action between the first and second cutters, characterized in that:
a part of the useless cast raw material placed inside from the placement opening is held via a damper that is openable and closable and positioned at a discharge port below the first and second cutter devices so as to avoid falling of the useless cast raw material from the discharge port below and to avoid accumulation of a crushed and broken recycled cast product by opening the damper using mobile means.

### TECHNICAL FIELD

The present invention relates to a breaking method of cast, such as lengthy objects, and provides a fast cast breaking method that ensures optimal size, shape, and weight of recycled cast products (recycled cast raw materials) from useless cast raw materials (useless cast).

### BACKGROUND ART

The cast breaking (crushing) method of the title and cutters most suitable to this method have been disclosed by the applicant of the present application in Japan, the United States, and Europe. Such disclosures include, for example, “hydraulic crushing and breaking apparatus of weirs, runners, and useless products for casting” in JP-A-6-106083,“cast breaking method and cutter structure” in JP-A-2002-224580, “crushing-breaking apparatus” in U.S. Pat. No. 5,791,573, and “an apparatus for crushing-breaking useless casting products using a fixed and a rocking cutter device and method for coating said cutting devices” in EP-A-0919283. The basic structures of these prior arts will be described in summaries (1) and (2) as follows.

The configuration of the summary (1) is common for all the references specified above. This configuration will now be described. This configuration includes first and second cutter devices each opening in the top and bottom faces, a number of projection-shaped first cutters provided to the first cutter device so as to protrude in a staggered fashion, the second cutter device and a number of projection-shaped second cutters provided to the second cutter device so as to protrude in a staggered fashion having a fact-to-face relation with the first cutter device and the first cutters, respectively, and mobile means (cylinder) that allows the second cutter device to move. A crushing and breaking operation (method) according to the summary (1) will now be described. Weirs and runners that are now useless and useless cast raw materials (referred to as useless cast raw materials) are placed inside from a placement opening (slot) defined between the first cutter device and the second cutter device when the second cutter device is retracted. The useless cast raw materials are then crushed and broken (referred to as being broken) using a fitting relation between the second cutters of the second cutter device that is moved forward by the cylinder and the first cutters of the first cutter device. In a case where an abnormal load is applied to the second cutters (second cutter device) in motion, the second cutters are retracted or stopped by the action of the safety mechanism. Broken recycled cast products (recycled cast) are discharged by natural fall from a discharge port (outlet) defined between the first cutter device and the second cutter device when the second cutter device is retracted.

The summary (2) is the mobile cutter device used in the cast breaking (crushing) method disclosed in “cast breaking method and cutter structure” in JP-A-2002-224580 supra and “crushing-breaking apparatus” in U.S. Pat. No. 5,791,573 supra. This device is configured in such a manner that a strip-shaped bottom mobile cutter device is provided to the discharge port in either one of the first and second cutter devices. The strip-shaped bottom mobile device prevents the falling of useless cast raw materials placed inside from the placement opening between the second cutter device and the first cutter device or recycled cast products when the second cutter device is retracted.

### DISCLOSURE OF THE INVENTION

In the summary (1) of the cited references, the recycled cast is discharged by natural fall from the discharge port defined between the first cutter device and the second cutter device when the second cutter device is retracted. It is, as a general rule, configured in such a manner that the discharge port is constantly closed by the mobile cutter device and opened when the necessity arises. Accordingly, there is a possibility that an unexpected load (burden) is applied to the mobile cutter device. This possibility poses a problem in durability, which raises a need to make the device robust enough to withstand such an expected load, or increases the cost due to extra materials required in order to ensure the durability and the robustness of the device. The summary (1) therefore needs to be improved in these points.

In the summary (2) of the cited references, the mobile cutter device corresponding to a damper of the invention is provided to the first cutter device on the lower side thereof in a movable manner, and the mobile cutter device is moved by the cylinder. Accordingly, it is configured in such a manner that the discharge port formed below the first and second cutter devices is closed or opened by means of extension or contraction of a piston rod of the cylinder. Hence, it is neither furnished with an automatic adjusting function nor configured so as to open and close the discharge port arbitrarily with an additional element, such as a load. Accordingly, the summary (2) has a problem in the point of discharging the recycled cast freely and arbitrarily from the discharge port.

### ADVANTAGES OF THE INVENTION

An invention set forth in claim 1 is configured in such a manner that a discharge port formed below second and first cutter devices is closed or opened via an automatically adjustable damper. Because the discharge port can be opened and closed arbitrarily using an additional element, such as a load, it is possible to lessen a load application to the damper. Accordingly, it becomes possible to ensure the durability of the damper and reduce both the size and the weight. Also, by adopting the configuration to satisfy the requirements to the damper, claim 1 achieves actual advantages that it can contribute to the management strategy of facilities by improving the economical efficiency and providing the most reasonable price and functionalities as an industrial machine.

In addition, the invention set forth in claim 1 is capable of allowing the crushed and broken recycled cast products to accumulate and/or preventing the accumulation via the damper that automatically opens and closes. Hence, it has actual advantages that a fuel needed for the melting is saved and/or the environment can be protected while making the processing of the useless cast raw materials easier and faster and ensuring the melting conditions and the economic efficiency, a stock of the useless cast raw materials can be lessened, and the spaces within the facilities can be utilized more efficiently, and the like.

Claim 1 is a cast breaking method for crushing and breaking a useless cast raw material by placing the useless cast raw material inside from a placement opening formed above by a first cutter device provided with a first cutter that converges toward a tip end and a second cutter device facing the first cutter device and provided with a second cutter that faces the first cutter and converges toward a tip end as well as having a fulcrum shaft on a lower side by means of a pressing action to press the placed useless cast raw material through a movement of the second cutter device along a circular trajectory via mobile means having a fulcrum shaft on an upper side of the second cutter device and a breaking action between the first and second cutters, characterized in that:
a part of the useless cast raw material placed inside from the placement opening is held via a damper that is openable and closable and positioned at a discharge port below the first and second cutter devices so as to avoid falling of the useless cast raw material from the discharge port below and to avoid accumulation of a crushed and broken recycled cast product by opening the damper using mobile means.

An invention set forth in claim 2 has actual advantages that the object of claim 1 can be achieved and that efficient mobile means for the damper most suitable to achieve this object can be provided.

Claim 2 is the cast breaking method characterized in that: the mobile means of the damper set forth in claim 1 is formed of a cylinder; an air pressure of the cylinder is adjustable; and the damper is automatically opened while a specific load is applied to the damper to mitigate an impact on the damper and to allow accumulation of a specific amount of the crushed and broken recycled cast product on the damper.

An invention set forth in claim 3 has actual advantages that the object of claim 1 can be achieved and that effective control means for the damper most suitable to achieve this object can be provided and the like.

Claim 3 is the cast breaking method characterized in that the air pressure of the cylinder set forth in claim 2 is adjustable manually or automatically.

An invention set forth in claim 4 has actual advantages that the object of claim 1 can be achieved and that an effective structure of the damper most suitable to achieve this object can be provided and the like.

Claim 4 is the cast breaking method characterized in that the damper set forth in claim 1 is configured in such a manner that a tip end is normally in close proximity to the lower side of the second cutter device so that the crushed and broken recycled cast product and/or the useless cast raw material falling from a close proximity region is almost 0.

An invention set forth in claim 5 has actual advantages that the object of claim 4 can be achieved and that an effective structure of the close proximity region of the damper and most suitable to achieve this object can be provided and the like.

Claim 5 is the cast breaking method characterized in that the close proximity region set forth in claim 4 makes a movement of the fulcrum shaft on the lower side of the second cutter device adjustable.

### BRIEF DESCRIPTION OF THE DRAWINGS

The drawings will now be described.

FIG. 1 is a schematic front view showing a state where a second cutter device is fully retracted and a placement opening defined between a first cutter device and the second cutter device is open.

FIG. 2 is a schematic front view showing a state where the second cutter device is being moved forward so that the placement opening between the first cutter device and the second cutter device is gradually closed.

FIG. 3 is a schematic front view showing a state where the second cutter device has fully moved forward and a discharge port defined between the first cutter device and the second cutter device is opened.

FIG. 4 is a schematic front view showing the same state as in FIG. 1 where the second cutter device is fully retracted.

FIG. 5 is a schematic front view showing an example of a crushing and/or breaking apparatus.

FIG. 6 is a schematic plan view showing an example of the crushing and/or breaking apparatus.

FIG. 7 is a schematic view of a right side face showing an example of the crushing and/or breaking apparatus.

FIG. 8 is a schematic view of a left side face showing an example of the crushing and/or breaking apparatus.

FIG. 9-1 is a perspective view showing an example of the shape of welded ribs provided to a damper.

FIG. 9-2 is a perspective view showing another example of FIG. 9-1.

FIG. 9-3 is a perspective view showing still another example of FIG. 9-1.

FIG. 9-4 is a perspective view showing still another example of FIG. 9-1.

FIG. 10-1 is a perspective view showing an example where the welded ribs provided to the damper are aligned linearly.

FIG. 10-2 is a perspective view showing another example of FIG. 10-1.

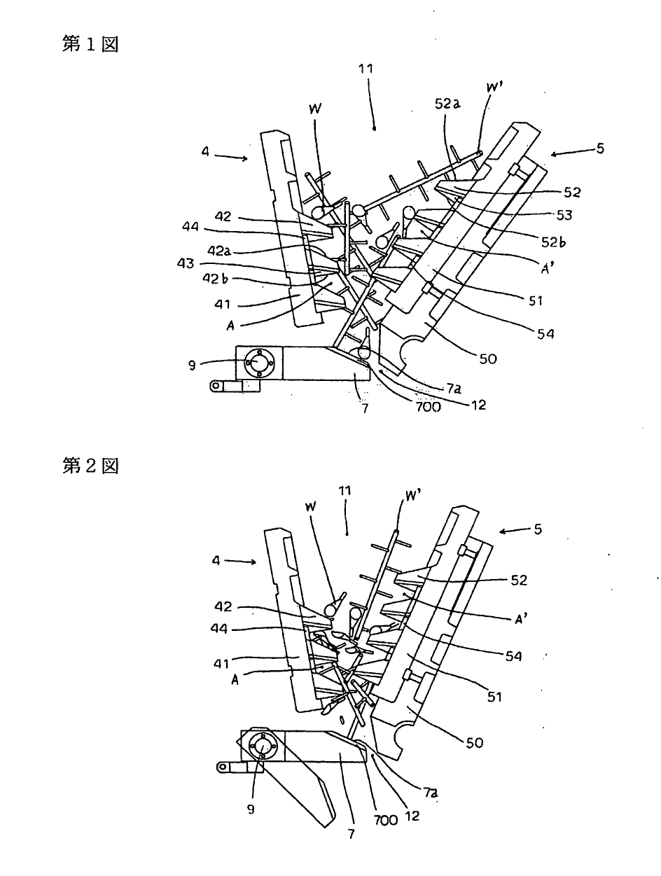

A breaking method of the invention will now be described on the basis of FIG. 1 through FIG. 4. As is shown in FIG. 1, useless cast raw materials (raw materials) are placed inside from a placement opening defined by the opening above the cutter holder of a second cutter device (mobile cutter device) and the opening above the cutter holder of a first cutter device (fixed cutter device or mobile cutter device) while the second cutter device is fully retracted. Of the raw material placed inside, by receiving relatively elongate raw materials (lengthy raw materials) falling from spaces between the first and second cutters (referred to as between the both cutters) by the damper, it becomes possible to accept the raw materials and/or lengthy raw materials described below in a reliable manner, and as will be described below, it becomes possible to crush and/or break, etc. (referred to as break) the raw materials and/or the lengthy raw materials, etc. efficiently in a reliable manner.

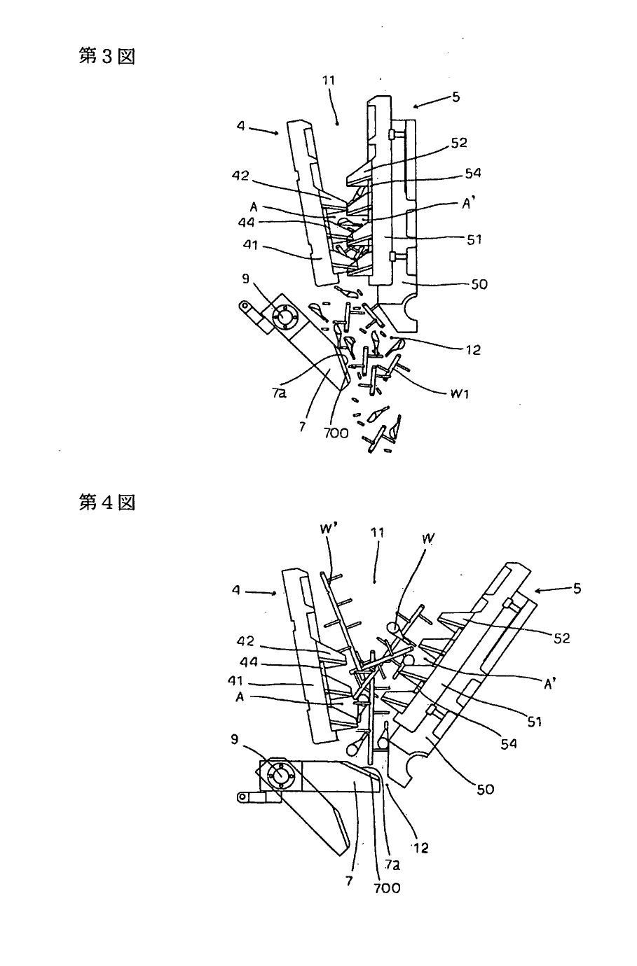

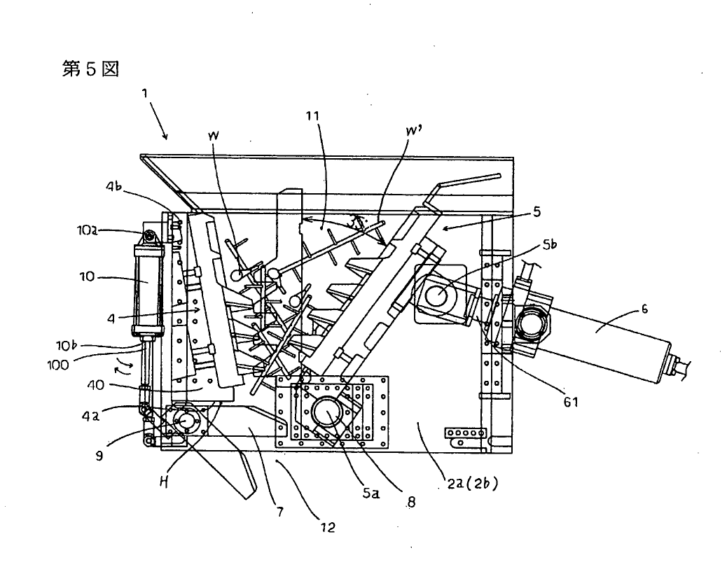

As are shown in FIG. 2 and FIG. 3, after the raw materials are placed inside from the placement opening, the second cutter device moves forward along a circular trajectory about the fulcrum, which is the fulcrum shaft on the lower side, and almost all the pressing force of the cylinder acts on the fulcrum shaft on the upper side of the second cutters. The pressing force thus acts between the both cutters in the vicinity thereof. Meanwhile, as the second cutter device moves forward along the circular trajectory, a strong crushing force and/or breaking force (referred to as the breaking force) is generated between the both cutters above the discharge port according to the principle of leverage in the vicinity of the fulcrum shaft on the lower side. The placed raw materials are thus broken smoothly in a reliable manner. This breaking is performed by utilizing the fitting relation between the both cutters. Because this breaking is performed at a low pressure in a reliable manner via the top and bottom fulcrum shafts and the cylinder and the configuration described above is adopted, this breaking has an actual advantage that it is useful in reducing the overall apparatus in size or in saving the running costs, and the like. Broken recycled cast products (recycled products) naturally fall successively toward the discharge port via the surfaces of the both cutters and/or clearing gasp between the both cutters. Hence, the breaking method of the invention can achieve actual advantages that it is useful in breaking raw materials at a low pressure in a reliable manner, reducing the cylinder and the over all apparatus in size or saving the running costs, and the like. It should be noted that in the invention, the damper is not directly involved with the breaking action as a general rule, and it is chiefly aimed at preventing the falling of lengthy raw materials and allowing the recycled products to accumulate thereon. However, in a case where a specific or higher load is applied to the damper (in a case where the recycled products accumulate thereon), the damper is allowed to move downward due to the weight of the recycled products and opens the discharge port (this automatic discharging caused by the load is not limited to the states shown in FIG. 2 and FIG. 3 and it can take place in another state). The accumulated recycled products are discharged by this opening toward the outside of the machine and/or a specified place (container) and collected.

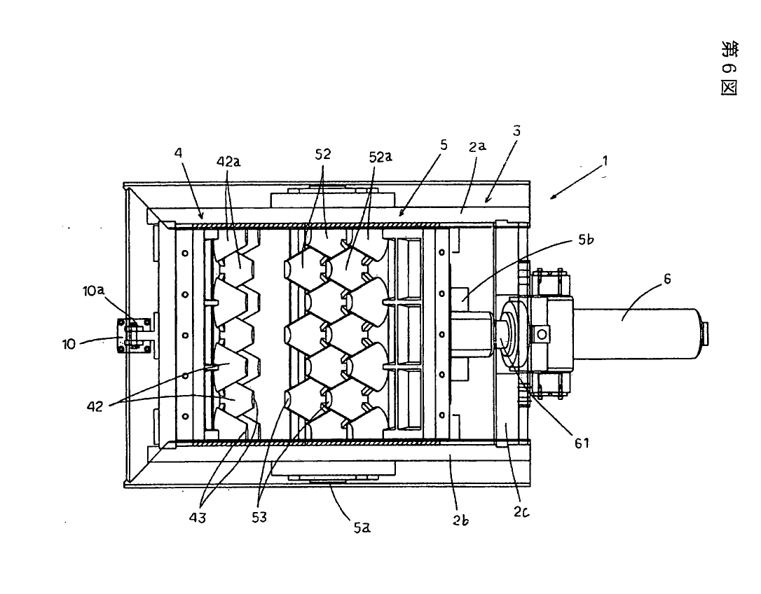

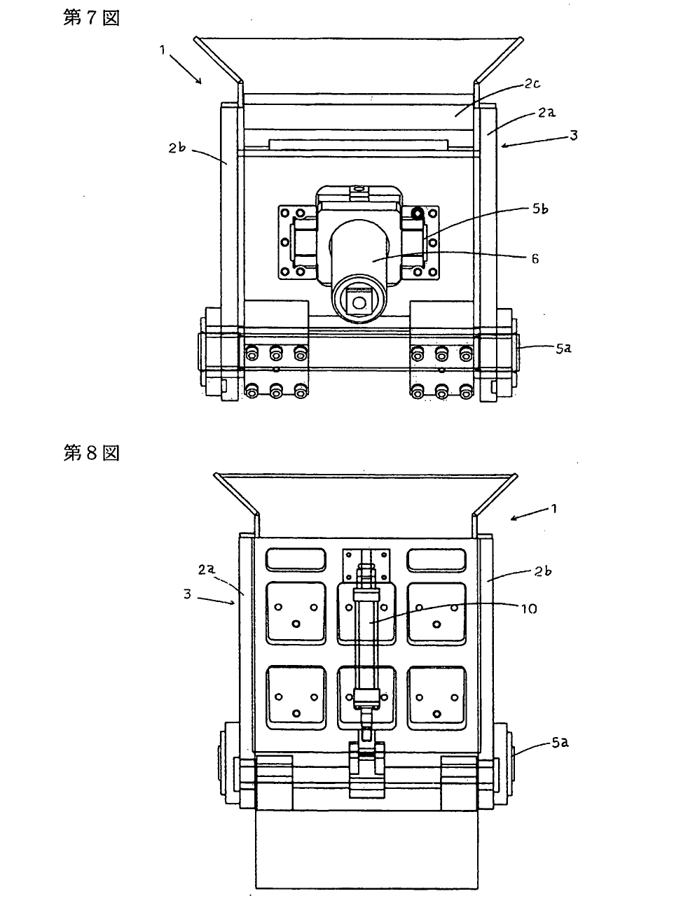

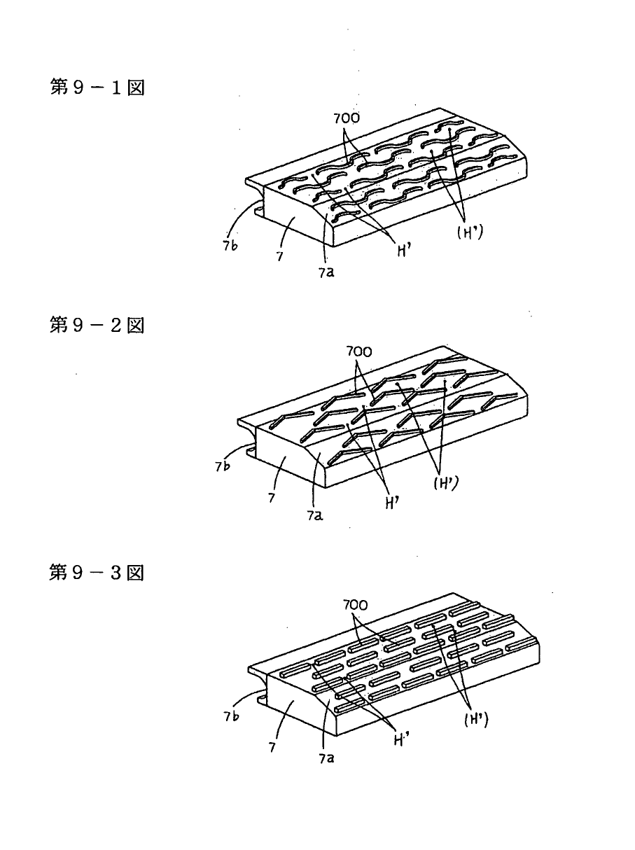

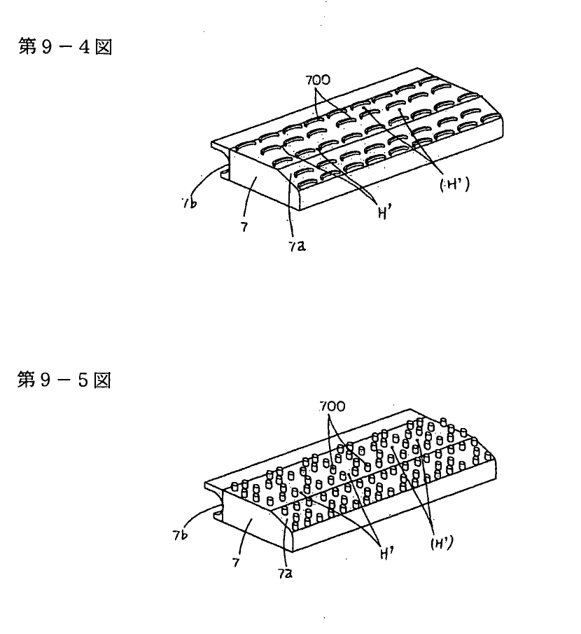

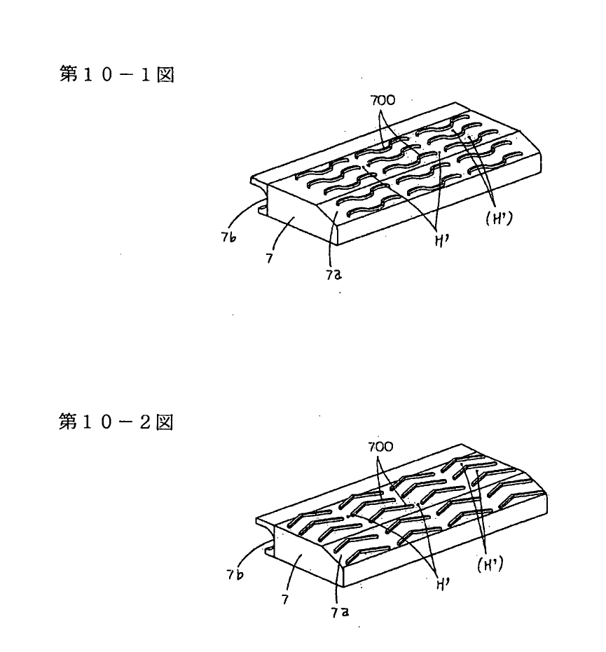

Thereafter, as is shown in FIG. 4, the second cutter device having fully moved forward performs a retraction operation by being retracted by means of extension and contraction of the piston rod of the cylinder until it is fully retracted, and in a case where the raw materials are present between the both cutters (partially including the recycled products), the second cutter device repeats the breaking operation same as described above by moving forward again. Hence, in a case where the raw materials are present between the both cutters, the second cutter device repetitively moves forward and retracts. In a case where the raw materials are absent between the both cutters, as a general rule, new raw materials are placed (supplied) inside from the placement opening as in the same manner as described above while the second cutter device is fully retracted. As an exceptional case, it may be configured in such a manner that when a burden is applied to the second cutter device while the second cutter device is moving forward, the second cutter device retracts first and then moves forward again. Also, the second cutter device retracts once it has fully moved forward. When a burden is applied to the second cutter device while it is retracting, it moves forward first and then retracts again. The configurations to allow the second cutter device to move forward and/or retract as above are merely examples and can be modified as needed under the control of the control means.

### BEST MODE FOR CARRYING OUT THE INVENTION

Hereinafter, an example of crushing and/or breaking apparatus used in a method of the invention will be described on the basis of the drawings. A crushing and/or breaking device 1 is chiefly composed of a frame 3 formed of side plates 2a and 2b and a bridging plate 2c and configured to open at the top and the bottom, a first cutter deice 4 (fixed cutter device) and a second cutter device 5 (mobile cutter device) provided to the frame 3, a cylinder 6 that allows the second cutter device 5 to move forward and retract, and a damper 7.

Initially, raw materials W are placed inside from a placement opening 11 formed above by the first cutter device 4 and the second cutter device 5 opposing the first cutter device 4. Then, the second cutter device 5 moves along a circular trajectory via mobile means having a fulcrum 5b on the upper side of the second cutter device 5 and presses the placed raw materials W. Meanwhile, the raw materials W are crushed and broken as they are broken by the first and second cutter devices 4 and 5.

The first cutter device 4 is formed of a substrate 40 for cutter holder attachment provided to the frame 3, a cutter holder 41 provided to the substrate 40 in a reattachable manner, a number of breaking and crushing first cutters 42 (bed cutters or rocking cutters) of a semi-truncated conical shape provided to the cutter holder 41 in a staggered fashion. A curved slope 42a of the first cutter 42 of the semi-truncated conical shape has an inclination that allows the broken cast (recyclable broken cast) to fall naturally in a reliable manner. The first cutters 42 are arrayed in a staggered fashion and spaces A are defined among the first cutters 42 for second cutters 52 of the semi-truncated conical shape of the second cutter device 5 described below to fit in. The second cutters 52 of the second cutter device 5 described below are fit in the spaces A. The broken cast falls down through fitting clearing gaps defined between the second cutters 52 of the second cutter device 5 fit in the spaces A and the first cutters 42 of the first cutter device 4. Numeral 43 in the drawings denotes bottom-side mountain portions protruding from the bottom side 42b in the shape of protrusion. The bottom-side mountain portions 43 break the raw materials W (cast products, useless cast raw materials, and so forth) and the like efficiently and prevent recycled cast W1 from being pinched between the first cutters 42 and/or between the second cutters 52. They are particularly effective when breaking lengthy raw materials W′. When this configuration is adopted, there can be achieved characteristics, for example, that scattering of the recycled cast W1 (raw materials) can be prevented and that the recycled cast W1 is pressed (pressing stress) toward the bottom of the cast breaking apparatus while it is broken (breaking force) at the same time. Numeral 44 in the drawings denotes breaking and crushing rib-shaped cutters provided among the first cutters 42.

The second cutter device 5 is formed of a movable plate 50 provided to be free to oscillate via an axis 8 serving as the fulcrum 5a on the lower side of the frame 3, a cutter holder 51 provided to the movable plate 50 in a reattachable manner, and a number of breaking and crushing second cutters 52 (rocking cutters) of the semi-truncated conical shape provided to the cutter holder 51 in a staggered fashion. The curved slope 52a of the second cutter 52 of the semi-truncated conical circular shape has an inclination that allows the recycled cast W1 to fall naturally in a reliable manner. The second cutters 52 are arrayed in a staggered fashion. The first cutters 42 of the semi-truncated conical shape of the first cutter device 4 are fit in spaces A′ among the second cutters 52 (the second cutters 52 and the first cutters 42 are inserted into the spaces A and the spaces A′, respectively). Numeral 53 in the drawings denotes bottom-side mountain portions protruding from the bottom side 52b in the shape of protrusion. The bottom-side mountain portions 53 break the raw materials W or the like efficiently and prevent the recycled cast W1 from being pinched between the first cutters 42 and/or between the second cutters 52. They are particularly effective when breaking lengthy raw materials W′. When this structure is adopted, there can be achieved characteristics, for example, that scattering of the recycled cast W1 can be prevented and that the recycled cast W1 is pressed toward the bottom of the cast breaking apparatus while it is broken at the same time. Numeral 54 in the drawings denotes breaking and crushing rib-shaped cutters provided among the second cutters 52.

At the fulcrum 5b on the upper side of the second cutter device 5, the second cutter device 5 moves forward and retracts (moves) about the axis 8 as the fulcrum shaft by means of extension and contraction of the piston rod 61 of the cylinder 6. More specifically, because the second cutters 52 on the mobile side come closer to and move apart from the first cutters 42 on the fixed side and the piston rod 61 is pivotally attached to the upper portion of the movable plate 50, a leverage motion mechanism is formed of the axis 8 (fulcrum) and the upper position at which the piston rod 61 is pivotally attached, and pushing by the leverage motion mechanism is conferred to the movable plate 50.

The damper 7 is provided in a movable manner to an axis 9 provided inside the frame 3 from the fulcrum shaft 4b of the first cutter device 4 while securing a slight spacing H from a horizontal lower end bottom portion 4a of the first cutter device 4, and it is allowed to move by a pneumatic cylinder 10. The pneumatic cylinder 10 is a cantilever having a fulcrum shaft 10a above the frame 3, and it is provided so that the piston rod side 10b is allowed to move. The air pressure of the pneumatic cylinder 10 can be adjusted by a valve. It adopts a configuration strong enough to withstand the load required by the damper 7 and controls the damper 7 to close and open automatically. Accordingly, for example, when the recycled cast W1 accumulates on the damper 7 and the air pressure rises above the pre-set air pressure, it automatically ascends, which causes a discharge port 12 to open. Hence, not only can the burden on the damper 7 be eliminated, but also the discharging can be performed in a reliable manner. By linking this discharging to the mobility of the second cutter device 5, it is possible to achieve actual advantages that the breaking can be performed efficiently in a reliable manner, the raw materials W can be placed inside, the recycled cast W1 can be discharged, and so forth. The recycled cast W1 is discharged from the discharge port 12 smoothly via a downward pointing inclination 7a provided to the damper 7. By providing the damper 7 to the discharge port 12, it is possible to have a characteristic that the falling of the lengthy raw materials W′ can be prevented. At the same time, the falling can be avoided more efficiently by the synergic effect with welded ribs 700 provided to the damper 7. The welded ribs 700 are normally welded to the damper 7 in the longitudinal direction or a direction orthogonal to the longitudinal direction (falling direction), and characterized in that they can provide a series of linear or inclined build-ups, etc., they can enhance the strength, they can prevent damage and wearing, and they can be used as breaking cutters, and so forth. Further, as has been described, the damper 7 is provided while securing the slight spacing H from the horizontal lower end bottom portion 4a, and the damper 7 is provided so as to be movable via the axis 9. The damper 7 is provided with a notch portion 7b for the axis 9 to be inserted therein. This configuration can provide actual advantages that the function of the damper 7 can be exerted and so forth. Numeral 100 in the drawings denotes the piston rod. It is possible to adopt an example where the welded ribs 700 are of a corrugated shape, a projection shape or the like, and provided in a staggered fashion or linearly in the downstream direction. Prevention of the falling of the raw materials W by the welded ribs 700 is facilitated by clearing gaps H′ provided among the welded ribs 700 and the clearing gaps H′ facilitate the falling of the recycle cast W1.

### DESCRIPTION OF REFERENCE NUMERALS AND SIGNS

1 crushing and/or breaking device

2a side plate

2b side plate

2c bridging plate

3 frame

4 first cutter device

4a lower end bottom portion

4b fulcrum shaft

40 substrate

41 cutter holder

42 cutter

42a slope

42b bottom side

43 bottom-side mountain portion

44 rib-shaped cutter

5 second cutter device

5a fulcrum on the lower side

5b fulcrum on the upper side

50 movable plate

51 cutter holder

52 cutter

52a slope

52b bottom side

53 bottom-side mountain portion

54 rib-shaped cutter

6 cylinder

61 piston rod

7 damper

7a downward pointing inclination

7b notch portion

700 rib

8 axis

9 axis

10 pneumatic cylinder

10a fulcrum shaft

10b piston rod side

100 piston rod

11 placement opening

12 discharge port

A space

A′ space

H spacing

H′ clearing gap

W raw material

W′ lengthy raw material

W1 recycled cast

### INDUSTRIAL APPLICABILITY

As has been described, the invention relates to a breaking method of cast, such as lengthy objects. Because the invention can provide a fast cast breaking method that ensures optimal size, shape, and weight of recycled cast products (recycled cast raw materials) from useless cast raw materials (useless cast), the invention is characterized in that it is useful in the cast industry and the industrial fields.

1. A cast breaking method for crushing and breaking a useless cast raw material by placing the useless cast raw material inside from a placement opening formed above by a first cutter device provided with a first cutter that converges toward a tip end and a second cutter device facing the first cutter device and provided with a second cutter that faces the first cutter and converges toward a tip end as well as having a fulcrum shaft on a lower side by means of a pressing action to press the placed useless cast raw material through a movement of the second cutter device along a circular trajectory via mobile means having a fulcrum shaft on an upper side of the second cutter device and a breaking action between the first and second cutters, characterized in that:
a damper that receives the useless cast raw material placed inside from the placement opening and/or a crushed and broken recycled cast product has a structure to be movable via a pneumatic cylinder capable of adjusting an air pressure to be regulated at a pre-set air pressure, so that it is configured in such a manner that the damper is allowed to move automatically via the pneumatic cylinder capable of adjusting the air pressure when an air pressure rises above the pre-set air pressure so as to open the discharge port for letting the crushed and broken recycled cast product be discharged from the opened discharge port; and
the damper is provided with welded ribs in such a manner that the welded ribs are formed in a corrugated shape or a projection shape or in a staggered fashion to form clearing gaps among the welded ribs with purposes of facilitating falling of the crushed and broken recycled cast product through the clearing gaps, enhancing strength of the damper and preventing damage and wearing thereof, and using the welded ribs of the damper as breaking cutters.

2-5. (canceled)
